(19) United States
(12) Patent Application Publication
(10) Pub. No.: US 2016/0354881 A1
(43) Pub. Date: Dec. 8, 2016

(54) MEASUREMENT APPARATUS, SYSTEM, AND METHOD OF MANUFACTURING ARTICLE

(71) Applicant: CANON KABUSHIKI KAISHA, Tokyo (JP)

(72) Inventors: Takeshi Suzuki, Utsunomiya-shi (JP); Yoshiyuki Kuramoto, Utsunomiya-shi (JP)

(21) Appl. No.: 15/168,592

(22) Filed: May 31, 2016

(30) Foreign Application Priority Data
Jun. 2, 2015 (JP) 2015-112401
May 17, 2016 (JP) 2016-099052

(51) Int. Cl. B23P 19/04; G01B 11/25; G06T 7/00

(52) U.S. Cl. CPC B23P 19/04; G06T 7/0057; G01B 11/25

(57) ABSTRACT

The present invention provides a measurement apparatus for measuring a shape of an object using pattern light, comprising a light source having a structure including a reflecting portion for reflecting light, a mask including a pattern region which includes reflecting regions for reflecting light, and configured to generate the pattern light, an optical system arranged between the light source and the mask, wherein the light source, the optical system, and the mask are arranged so that light emitted from the light source is incident on the reflecting region via the optical system, is reflected by the reflecting region to return to the light source via the optical system, and then is reflected by the reflecting portion of the light source to enter the transmitting region via the optical system.

### BACKGROUND OF THE INVENTION

### Field of the Invention

The present invention relates to a measurement apparatus for measuring the shape of an object, a system including the measurement apparatus, and a method of manufacturing an article.

### Description of the Related Art

There is known a measurement apparatus using a pattern projection method as a measurement apparatus for measuring the three-dimensional shape of an object (see Japanese Patent No. 2517062 and Japanese Patent Laid-Open No. 2010-538269). The pattern projection method is a method of measuring the shape of an object by projecting the pattern of a mask on the object, and detecting, from an image obtained by imaging the object on which the pattern of the mask is projected, a distortion of a projection pattern which occurs in accordance with the shape of the object.

In the measurement apparatus using the pattern projection method, most light with which a mask is irradiated is not transmitted through the mask, and is thus in vain without being used to project the pattern of the mask on the object. Therefore, the measurement apparatus is desired to efficiently use light, with which the mask is irradiated, to project the pattern of the mask on the object.

### SUMMARY OF THE INVENTION

The present invention provides, for example, a measurement apparatus advantageous in efficiently using light.

According to one aspect of the present invention, there is provided a measurement apparatus for measuring a shape of an object using pattern light, comprising: a light source having a structure including a light emitting portion for emitting light and a reflecting portion for reflecting light; a mask including a pattern region in which transmitting regions for transmitting light and reflecting regions for reflecting light are periodically arranged, and configured to generate the pattern light; an optical system arranged between the light source and the mask; an imaging unit configured to image the object irradiated with the pattern light; and a processor configured to obtain the shape of the object based on an image obtained by the imaging unit, wherein the light source, the optical system, and the mask are arranged so that light emitted from the light source is incident on the reflecting region of the mask via the optical system, is reflected by the reflecting region to return to the light source via the optical system, and then is reflected by the reflecting portion of the light source to enter the transmitting region of the mask via the optical system.

Further features of the present invention will become apparent from the following description of exemplary embodiments with reference to the attached drawings.

### BRIEF DESCRIPTION OF THE DRAWINGS

FIG. 1 is a schematic view showing a measurement apparatus according to the first embodiment;

FIG. 2 is a view showing an example of the arrangement of a light source;

FIG. 3 is a view showing an example of a pattern formed on a mask;

FIG. 4 is a view showing the arrangement of an irradiating unit according to the first embodiment;

FIG. 5 is a view showing the positional relationship between the optical axis of light entering the mask and the transmitting regions of the mask;

FIG. 6 is a view showing the arrangement of an irradiating unit according to the second embodiment;

FIG. 7 is a view showing the positional relationship between the optical axis of light entering a mask and the transmitting regions of the mask;

FIG. 8A is a view showing the arrangement of an irradiating unit according to the third embodiment;

FIG. 8B is a view showing the arrangement of the irradiating unit according to the third embodiment; and

FIG. 9 is a view showing the configuration of a control system.

### DESCRIPTION OF THE EMBODIMENTS

Exemplary embodiments of the present invention will be described below with reference to the accompanying drawings. Note that the same reference numerals denote the same members throughout the drawings, and a repetitive description thereof will not be given.

### First Embodiment

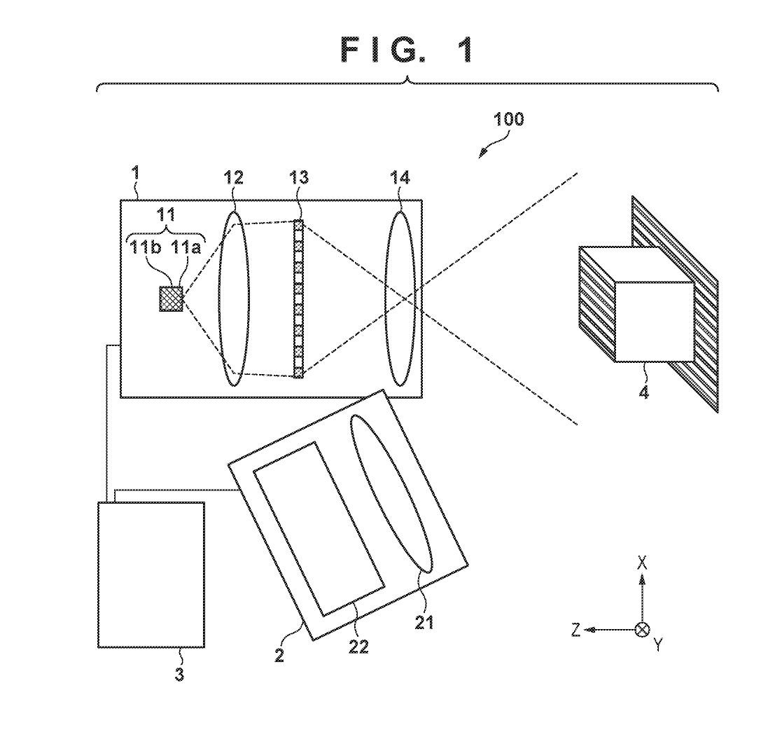

A measurement apparatus 100 according to the first embodiment of the present invention will be described with reference to FIG. 1. FIG. 1 is a schematic view showing the measurement apparatus 100 according to the first embodiment. The measurement apparatus 100 according to the first embodiment includes, for example, an irradiating unit 1, an imaging unit 2, and a processor 3, and measures the shape of an object 4 using the pattern projection method. The pattern projection method is a method of measuring the shape of the object 4 by projecting, on the object 4, a pattern generated on a mask, and detecting, from an image obtained by imaging the object 4 on which the pattern is projected, a distortion of a projection pattern which occurs in accordance with the shape of the object 4.

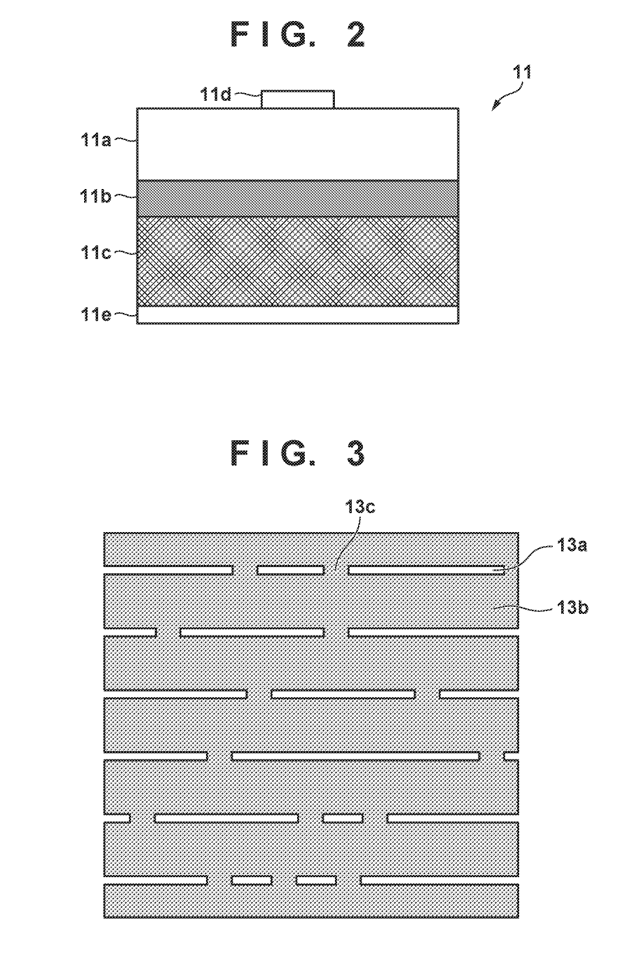

The irradiating unit 1 can include, for example, a light source 11, an optical system 12, a mask 13, and a projecting unit 14. As shown in FIG. 2, for example, the light source 11 can include an LED (Light Emitting Diode) having a structure in which a light emitting layer 11a (light emitting portion) for emitting light and a reflecting layer 11b (reflecting portion) for reflecting light are stacked. FIG. 2 is a view showing an example of the arrangement of the light source 11 (LED) used in the measurement apparatus 100 according to the first embodiment. The light source 11 has a structure in which the reflecting layer 11b for reflecting light and the light emitting layer 11a for emitting light are stacked on a support substrate 11c, and electrodes 11d and 11e are provided on the surfaces of the light emitting layer 11a and support substrate 11c, respectively. Providing the reflecting layer 11b between the light emitting layer 11a and the support substrate 11c makes it possible to efficiently extract, from the surface of the light emitting layer 11a, light generated in the light emitting layer 11a. Note that, for example, the reflecting layer 11b can be made of a metal material, and the light emitting layer 11a can be made of a semiconductor material. The reflecting layer 11b may be made to have a reflectance of 70% or more.

As shown in FIG. 3, for example, the mask 13 includes a pattern region in which transmitting regions 13a for transmitting light and reflecting regions 13b for reflecting light are periodically arranged, and generates pattern light by light transmitted through the transmitting regions 13a. FIG. 3 is a view showing an example of the pattern (pattern region) formed on the mask 13. To identify each of a plurality of line elements as the transmitting regions 13a, a pattern obtained by providing, for each line element, some dot elements 13c which do not transmit light, a so called “dot line pattern” can be used as the mask 13 according to the first embodiment. Using the “dot line pattern” can associate the positions of the dot elements 13c on the mask with the positions of dot elements in the pattern projected on the object 4. Thus, it is possible to accurately measure the shape of the object 4 using the pattern projection method. The mask 13 can be configured so that the area of the reflecting regions 13b in the pattern region is larger than that of the transmitting regions 13a.

The optical system 12 is arranged between the light source 11 and the mask 13. The optical system 12 includes, for example, a plurality of optical elements (lenses), and can be configured so that light perpendicularly enters the pattern region of the mask 13. Furthermore, the projecting unit 14 includes, for example, a plurality of optical elements (lenses), and projects the pattern of the mask 13 on the object 4 by irradiating the object 4 with the pattern light generated by the mask 13.

The imaging unit 2 includes, for example, an imaging optical system 21 and an image sensor 22, and images the object 4 irradiated with the pattern light. The imaging optical system 21 includes, for example, a plurality of optical elements (lenses), and forms, on the imaging plane of the image sensor 22, an image of light reflected or scattered by the object 4. The image sensor 22 includes, for example, a CCD sensor or CMOS sensor, and obtains an image of the object 4 irradiated with the pattern light by detecting, for each pixel, the intensity of the light entering the imaging plane. The processor 3 executes processing of obtaining the shape of the object 4 based on the image obtained by the imaging unit 2. The processor 3 according to the first embodiment has a function as a control unit for controlling the respective units (the irradiating unit 1, the imaging unit 2, and the like) of the measurement apparatus 100 in addition to a function of executing the processing of obtaining the shape of the object 4. In the measurement apparatus 100 according to the first embodiment, the processor 3 has a function as a control unit. The present invention, however, is not limited to this, and a control unit may be provided separately from the processor 3.

In the measurement apparatus 100 having the above arrangement, most light with which the mask 13 is irradiated by the irradiating unit 1 is not transmitted through the transmitting regions 13a formed on the mask 13, and is thus in vain without being used to project the pattern of the mask 13 on the object 4. Therefore, for example, in terms of the power consumption, the measurement apparatus 100 desirably, efficiently uses the light, with which the mask 13 is irradiated, to project the pattern of the mask 13 on the object 4.

For example, the measurement apparatus 100 may be used to measure the shape of the moving object 4. To accurately measure the shape of the moving object 4, a measurement error caused by a motion blur which occurs when imaging the object 4 by the imaging unit 2 may be reduced. As a method of reducing a measurement error caused by a motion blur, there is provided a method of shortening an imaging time to decrease the moving amount of the object 4 within the imaging time. If, however, only the imaging time is simply shortened, the amount of light entering the imaging unit 2 (image sensor 22) decreases, and thus the measurement accuracy of the shape of the object 4 can deteriorate due to the influence of dark noise or shot noise generated in the image sensor 22. Increasing the intensity of the light emitted from the light source 11 of the irradiating unit 1 to suppress the deterioration in the measurement accuracy can be disadvantageous in terms of the power consumption.

If a motion blur occurs, the line elements projected on the object 4 cannot be separated in the image obtained by the imaging unit 2, resulting in a measurement error. To separate the line elements in the image, the pitch between the line elements (transmitting regions 13a) on the mask 13 is increased. However, if the pitch between the line elements on the mask 13 is increased, that is, the ratio of the transmitting regions 13a to the entire pattern of the mask 13 is decreased, the practical efficiency (to be referred to as the transmission efficiency hereinafter) at which the light emitted from the light source 11 is transmitted through the mask 13 can lower.

The measurement apparatus 100 (optical system 12) according to the first embodiment is configured so that the light entering the reflecting region 13b of the mask 13 is reflected by the reflecting region 13b to return to the light source 11 via the optical system 12, and is reflected by the reflecting layer 11b of the light source 11 to enter the transmitting region 13a of the mask 13 via the optical system 12. When the light reflected by the reflecting region 13b of the mask 13 is reflected by the reflecting layer 11b of the light source 11 to enter the mask 13 again, an image of the pattern region of the mask 13 can be formed on the mask 13 (a plane in which the mask 13 is arranged). At this time, the light source 11 and the mask 13 are arranged so that the peak of the light intensity in the image of the pattern region formed on the mask 13 by the optical system 12 is positioned in the transmitting region 13a of the mask 13. For example, the light source 11 and the mask 13 are arranged so that an image of the reflecting region 13b in the image of the pattern region formed on the mask 13 is positioned in the transmitting region 13a of the mask 13, desirably the image of the reflecting region 13b covers the transmitting region 13a of the mask 13. By arranging the light source 11 and the mask 13 as described above, the intensity of the light transmitted through the transmitting region 13a of the mask 13 can be increased, thereby improving the transmission efficiency.

A chrome film which readily absorbs light is generally provided in each reflecting region 13b of the mask 13. Since the measurement apparatus 100 according to the first embodiment uses the light reflected by the reflecting region 13b of the mask 13, it is desirable that the reflectance with respect to the light from the light source 11 is maximized in the reflecting region 13b. For example, the reflectance may be 70% or more. In the first embodiment, a film such as an aluminium film or silver film can be provided in each reflecting region 13b of the mask 13 so that the reflectance with respect to the light from the light source 11 becomes 70% or more.

Transmission efficiency Sn can be obtained by a geometric series given by:

Sn=a(1−rⁿ)/(1−r) (1)

where the first term a represents the ratio (duty) of the transmitting regions 13a to the entire pattern of the mask 13, and a common ratio r represents the product of the reflectance of the reflecting regions 13b of the mask 13 and the reflectance of the reflecting layer 11b of the light source 11. For example, the transmission efficiency Sn is 0.48 when the duty is 0.25, the reflectance of the reflecting regions 13b is 80%, and the reflectance of the reflecting layer 11b is 80%. This indicates that the transmission efficiency Sn can be improved by 1.92 times, as compared with the conventional arrangement (Sn=0.25) which does not use the light reflected by the mask 13 for illumination of the mask 13.

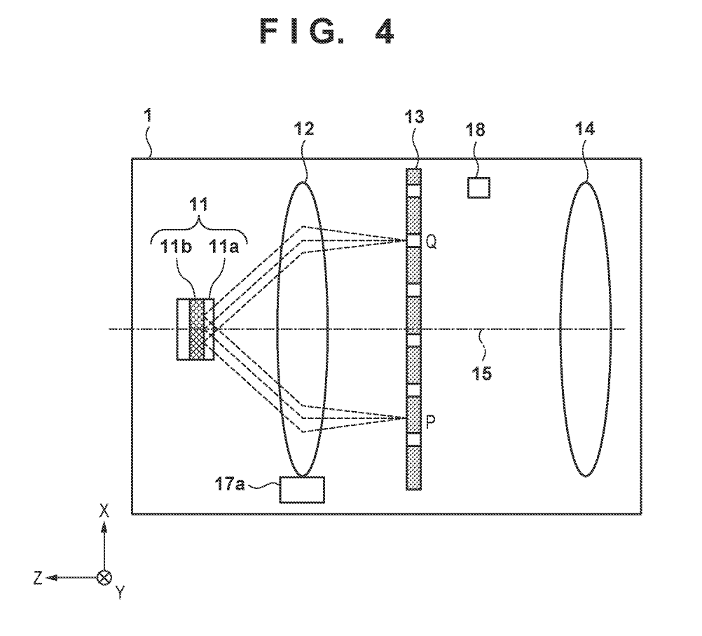

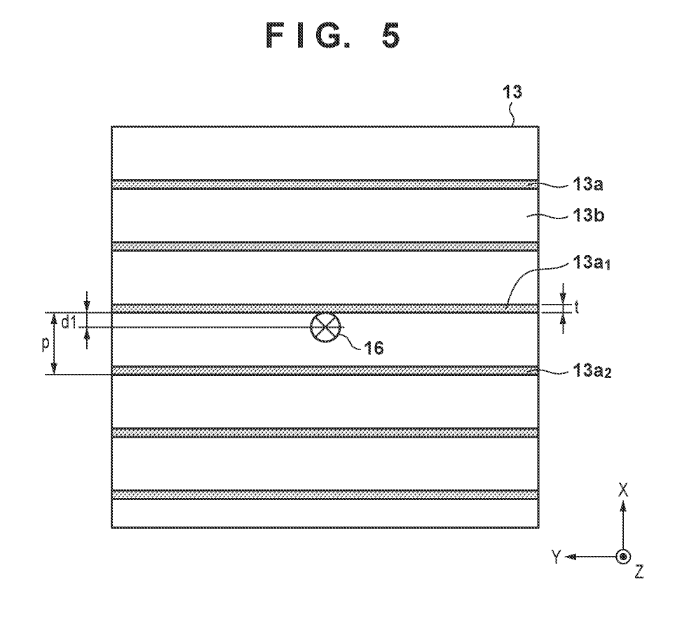

The arrangement of the irradiating unit 1 for positioning, in the transmitting region 13a of the mask 13, the peak of the light intensity in the image of the pattern region formed on the mask 13 will be described with reference to FIGS. 4 and 5. FIG. 4 is a view showing the arrangement of the light source 11, optical system 12, mask 13, and projecting unit 14 in the irradiating unit 1 according to the first embodiment. FIG. 5 is a view showing the positional relationship between an optical axis 15 (the optical axis of the light entering the pattern region of the mask 13) of the optical system 12 and the transmitting regions 13a of the mask 13. In the mask 13 shown in FIG. 5, the dot elements 13c are not illustrated.

In the irradiating unit 1 according to the first embodiment, the optical system 12 and the mask 13 are arranged so that the pattern region of the mask 13 does not have twofold symmetry with respect to the optical axis 15 of the optical system 12, as shown in FIG. 5. That is, the optical system 12 and the mask 13 are arranged so that the distances between an intersecting point 16 of the mask 13 and the optical axis 15 of the optical system 12 and transmitting regions 13a₁ and 13a₂ sandwiching the intersecting point 16 are different from each other so as to satisfy:

0≦d1<(p−t)/2 (2)

where p represents the pitch between the transmitting regions 13a in the mask 13, t represents the width (X direction) of each transmitting region 13a, and d1 represents the distance between the intersecting point 16 and the transmitting region 13a of the two transmitting regions 13a₁ and 13a₂ sandwiching the intersecting point 16, which is closer to the intersecting point 16.

By arranging the optical system 12 and the mask 13 as described above, for example, the light reflected at a location P in the reflecting region 13b of the mask 13 can be reflected by the reflecting layer 11b of the light source 11 to enter the transmitting region 13a (a location Q) of the mask 13, as shown in FIG. 4. That is, the transmission efficiency can be improved.

Note that in the measurement apparatus 100 according to the first embodiment, a first change unit 17a for changing the relative positions of the optical system 12 and mask 13 may be provided in a direction (for example, the X direction) perpendicular to the optical axis 15 of the optical system 12. By providing the first change unit 17a as described above, it is possible to adjust the relative positions of the optical system 12 and mask 13 to improve the transmission efficiency by increasing the intensity of the light transmitted through the transmitting region 13a of the mask 13. In the measurement apparatus 100 according to the first embodiment, a detector 18 for detecting the intensity of the light transmitted through the transmitting region 13a of the mask 13, that is, the intensity of the pattern light generated by the mask 13 may be provided. In this case, the processor 3 can control the first change unit 17a based on the detection result of the detector 18 to adjust the relative positions of the optical system 12 and mask 13 so that the intensity of the pattern light satisfies an allowable value (for example, the intensity of the pattern light becomes highest). In the first embodiment, the first change unit 17a is configured to change the relative positions of the optical system 12 and mask 13 by driving the optical system 12. The present invention, however, is not limited to this. For example, the first change unit 17a may be configured to drive the mask 13 or both the optical system 12 and the mask 13.

As described above, in the measurement apparatus 100 according to the first embodiment, the optical system 12 and the mask 13 are arranged so that the peak of the light intensity in the image of the pattern region formed on the mask 13 is positioned in the transmitting region 13a of the mask 13. This can improve the transmission efficiency, thereby increasing the intensity of the light transmitted through the transmitting region 13a of the mask 13.

### Second Embodiment

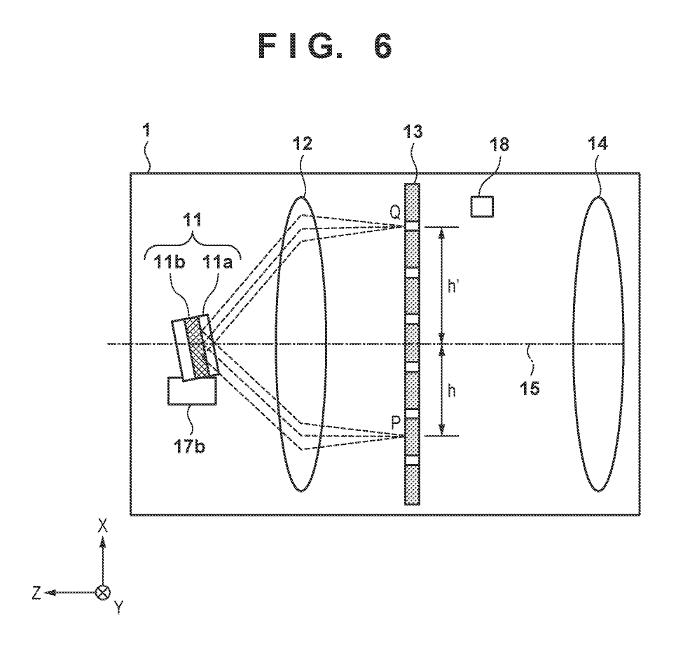

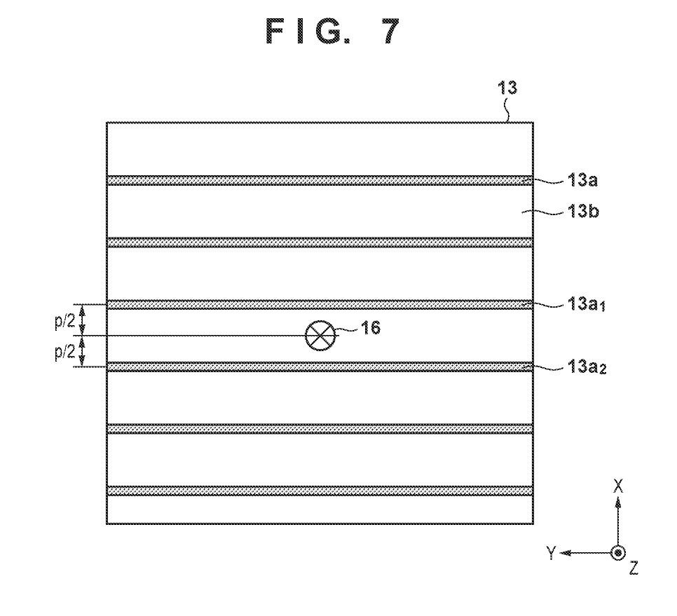

A measurement apparatus according to the second embodiment of the present invention will be described. The measurement apparatus according to the second embodiment is different from the measurement apparatus 100 according to the first embodiment in the arrangement of an irradiating unit 1. The irradiating unit 1 according to the second embodiment arranges, in a transmitting region 13a of a mask 13, the peak of the light intensity in an image of a pattern region formed on the mask 13 by relatively tilting a light source 11, and an optical system 12 and the mask 13. The arrangement of the irradiating unit 1 in the measurement apparatus according to the second embodiment will be described with reference to FIGS. 6 and 7. FIG. 6 is a view showing the arrangement of the light source 11, the optical system 12, the mask 13, and a projecting unit 14 in the irradiating unit 1 according to the second embodiment. FIG. 7 is a view showing the positional relationship between an optical axis 15 (the optical axis of light entering the pattern region of the mask 13) of the optical system 12 and the transmitting regions 13a of the mask. In the irradiating unit 1 according to the second embodiment, the optical system 12 and the mask 13 can be arranged so that the distances between an intersecting point 16 of the mask 13 and the optical axis 15 of the optical system 12 and two transmitting regions 13a₁ and 13a₂ sandwiching the intersecting point 16 are equal to each other, as shown in FIG. 7. However, the present invention is not limited to this. As shown in FIG. 5, the distances between the intersecting point 16 and the transmitting regions 13a₁ and 13a₂ may be different from each other.

In the irradiating unit 1 according to the second embodiment, as shown in FIG. 6, the surface of the reflecting layer of the light source 11, and the optical system 12 and mask 13 are relatively tilted so that the peak of the light intensity in the image of the pattern region formed on the mask 13 is positioned in the transmitting region 13a of the mask 13. This can set different distances (h and h′) from the optical axis 15 at a location P in a reflecting region 13b of the mask 13 and a location Q on the mask 13 at which the light reflected at the location P is reflected by a reflecting layer 11b of the light source 11 to enter the mask 13. Therefore, the light reflected by the reflecting region 13b of the mask 13 can be reflected by the reflecting layer 11b of the light source 11 to enter the transmitting region 13a of the mask 13 via the optical system 12.

In the measurement apparatus according to the second embodiment, a second change unit 17b for changing the relative tilts of the light source 11 and the optical system 12 and mask 13 may be provided. By providing the second change unit 17b as described above, it is possible to adjust the relative tilts of the light source 11 and the optical system 12 and mask 13 so as to improve the transmission efficiency and increase the intensity of the light transmitted through the transmitting region 13a of the mask 13. Furthermore, in the measurement apparatus according to the second embodiment, a detector 18 for detecting the intensity of the light transmitted through the transmitting region 13a of the mask 13, that is, the intensity of the pattern light generated by the mask 13 may be provided. In this case, a processor 3 can control the second change unit 17b based on the detection result of the detector 18 to adjust the relative tilts of the light source 11 and the mask 13 (optical system 12) so that the intensity of the pattern light satisfies an allowable value (for example, the intensity of the pattern light becomes highest). In the second embodiment, the second change unit 17b is configured to change the tilt of the light source 11 by driving the light source 11. The present invention, however, is not limited to this. For example, the second change unit 17b may be configured to drive the mask 13 or both the light source 11 and the mask 13.

### Third Embodiment

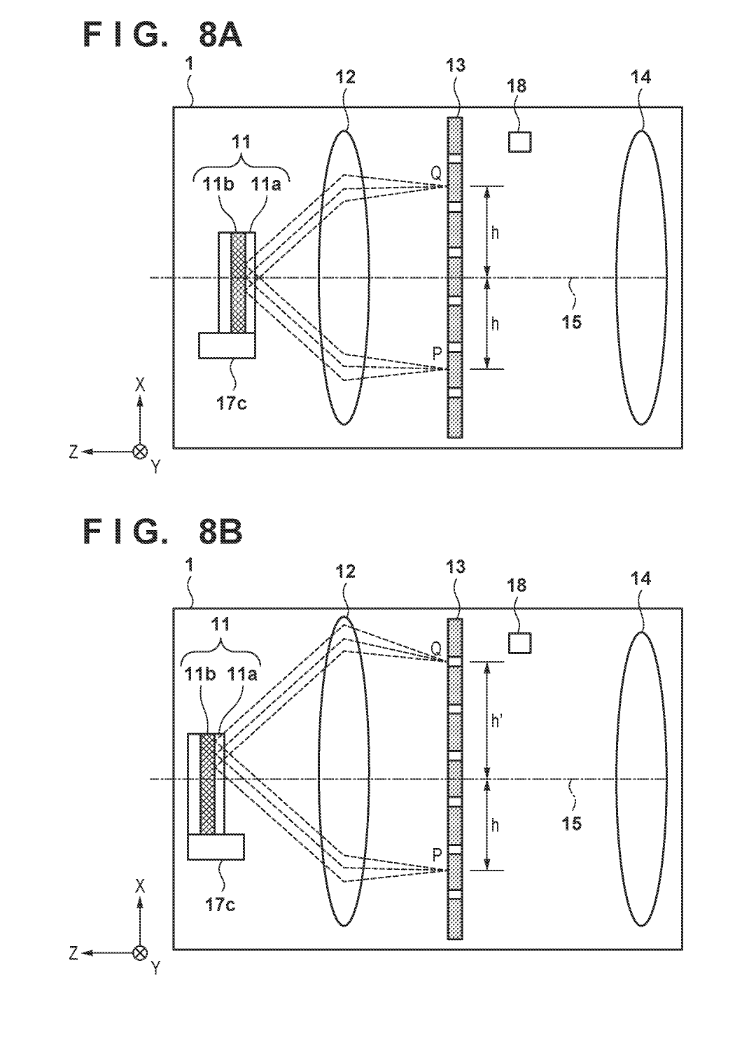

A measurement apparatus according to the third embodiment of the present invention will be described. The measurement apparatus according to the third embodiment is different from the measurement apparatus 100 according to the first embodiment in the arrangement of an irradiating unit 1. In the irradiating unit 1 according to the third embodiment, the relative positions of a light source 11 and a mask 13 in a direction parallel to an optical axis 15 are adjusted so that an image of a pattern region of the mask 13 is defocused and formed on the mask 13. That is, the irradiating unit 1 according to the third embodiment arranges, in a transmitting region 13a of the mask 13, the peak of the light intensity in an image of the pattern region formed on the mask 13 by defocusing and forming the image of the pattern region of the mask 13 on the mask 13. The arrangement of the irradiating unit 1 in the measurement apparatus according to the third embodiment will be described below with reference to FIGS. 8A and 8B. FIGS. 8A and 8B are views each showing the arrangement of the light source 11, an optical system 12, the mask 13, and a projecting unit 14 in the irradiating unit 1 according to the third embodiment. The optical system 12 forms a Koehler illumination optical system, and is configured to illuminate the pattern region of the mask 13 by superimposing light beams from the respective points of the light source 11. In the irradiating unit 1 according to the third embodiment, the light source 11 and the mask 13 can be arranged so that the distances between an intersecting point 16 of the mask 13 and the optical axis 15 of the optical system 12 and two transmitting regions 13a₁ and 13a₂ sandwiching the intersecting point 16 are equal to each other, as shown in FIG. 7. However, the present invention is not limited to this. As shown in FIG. 5, the distances between the intersecting point 16 and the transmitting regions 13a₁ and 13a₂ may be different from each other.

FIG. 8A is a view showing a state in which the image of the pattern region of the mask 13 is formed on the mask 13 at a unity magnification. In this state, the distances from the optical axis 15 at a location P in a reflecting region 13b of the mask 13 and a location Q on the mask 13 at which the light reflected at the location P is reflected by a reflecting layer 11b of the light source 11 to enter the mask 13 are equal to each other. That is, the light reflected by the reflecting region 13b of the mask 13 cannot be reflected by the reflecting layer 11b of the light source 11 to enter the transmitting region 13a of the mask 13. Therefore, in the measurement apparatus according to the third embodiment, as shown in FIG. 8B, the light source 11 and the mask 13 are arranged so that the image of the pattern region of the mask 13 is defocused and formed on the mask 13 via the optical system 12. This can set different distances (h and h′) from the optical axis 15 at the location P in the reflecting region 13b of the mask 13 and the location Q on the mask at which the light reflected at the location P is reflected by the reflecting layer 11b of the light source 11 to enter the mask 13 via the optical system 12. Thus, the light reflected by the reflecting region 13b of the mask 13 can be reflected by the reflecting layer 11b of the light source 11 to enter the transmitting region 13a of the mask 13 via the optical system 12.

In the measurement apparatus according to the third embodiment, a third change unit 17c for changing the relative positions of the light source 11 and mask 13 may be provided in a direction (for example, the Z direction) parallel to the optical axis 15 of the light entering the mask 13. By providing the third change unit 17c as described above, it is possible to adjust the relative positions of the light source 11 and mask 13 so as to increase the intensity of the light transmitted through the transmitting region 13a of the mask 13 and improve the transmission efficiency. Furthermore, in the measurement apparatus according to the third embodiment, a detector 18 for detecting the intensity of the light transmitted through the transmitting region 13a of the mask 13, that is, the intensity of the pattern light generated by the mask 13 may be provided. In this case, a processor 3 can control the third change unit 17c based on the detection result of the detector 18 to adjust the relative positions of the light source 11 and mask 13 so that the intensity of the pattern light satisfies an allowable value (for example, the intensity of the pattern light becomes highest). In the third embodiment, the third change unit 17c is configured to change the relative positions of the light source 11 and mask 13 by driving the light source 11. The present invention, however, is not limited to this. For example, the third change unit 17c may be configured to drive the mask 13 or both the light source 11 and the mask 13. Furthermore, the focal length of the optical system 12 may be changed. In this embodiment, the optical system 12 is a Koehler illumination optical system. However, the optical system 12 may be formed as an imaging optical system.

Note that it is possible to implement an embodiment by combining the first to third embodiments. For example, it is possible to form a measurement apparatus by combining some of the first, second, and third change units.

### Fourth Embodiment

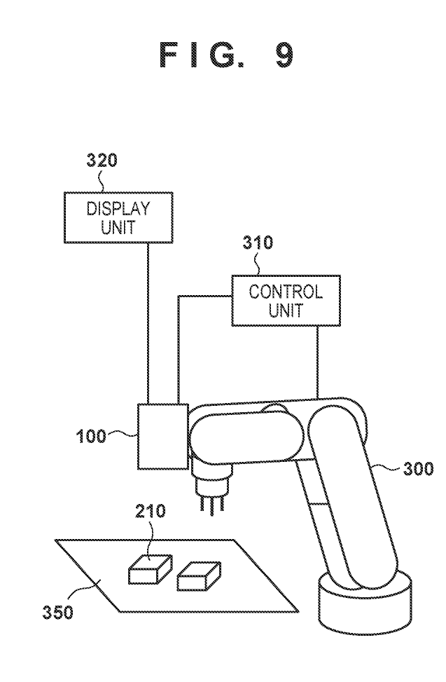

Each of the above-described measurement apparatuses can be used while being supported by a given support member. In this embodiment, a control system which is attached to a robot arm 300 (gripping apparatus) and used, as shown in FIG. 9, will be described as an example. A measurement apparatus 100 images an object 210 placed on a support table 350 by projecting pattern light on the object 210, thereby acquiring an image. The control unit of the measurement apparatus 100 or a control unit 310 which has acquired image data from the control unit of the measurement apparatus 100 obtains the position and orientation of the object 210, and the control unit 310 acquires information of the obtained position and orientation. Based on the information of the position and orientation, the control unit 310 controls the robot arm 300 by sending a driving command to the robot arm 300. The robot arm 300 holds the object 210 by a robot hand or the like (gripping portion) at the distal end to perform movement such as translation and rotation. Furthermore, the robot arm 300 can assemble the object 210 with other parts, thereby manufacturing an article formed from a plurality of parts, for example, an electronic circuit substrate or machine. It is also possible to manufacture an article by processing the moved object 210. The control unit 310 includes an arithmetic unit such as a CPU, and a storage device such as a memory. Note that a control unit for controlling the robot may be provided outside the control unit 310. Furthermore, measurement data measured by the measurement apparatus 100 and the obtained image may be displayed on a display unit 320 such as a display.

### Other Embodiments

Embodiment(s) of the present invention (the processor, the controller) can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-112401 filed on Jun. 2, 2015, and No. 2016-099052 filed on May 17, 2016, which are hereby incorporated by reference herein in their entirety.

What is claimed is:

1. A measurement apparatus for measuring a shape of an object using pattern light, comprising:
a light source having a structure including a light emitting portion for emitting light and a reflecting portion for reflecting light;
a mask including a pattern region in which transmitting regions for transmitting light and reflecting regions for reflecting light are periodically arranged, and configured to generate the pattern light;
an optical system arranged between the light source and the mask;
an imaging unit configured to image the object irradiated with the pattern light; and
a processor configured to obtain the shape of the object based on an image obtained by the imaging unit,
wherein the light source, the optical system, and the mask are arranged so that light emitted from the light source is incident on the reflecting region of the mask via the optical system, is reflected by the reflecting region to return to the light source via the optical system, and then is reflected by the reflecting portion of the light source to enter the transmitting region of the mask via the optical system.

2. The apparatus according to claim 1, further comprising:
a detector configured to detect an intensity of the pattern light generated by the mask,
wherein the arrangement of at least one of the light source, the optical system, and the mask is adjusted based on a detection result of the detector.

3. The apparatus according to claim 1, wherein the optical system and the mask are arranged so that distances between an intersecting point of the mask and an optical axis of the optical system and two of the transmitting regions sandwiching the intersecting point are different from each other.

4. The apparatus according to claim 1, further comprising:
a first change unit configured to change relative positions of the optical system and the mask in a direction perpendicular to an optical axis of the optical system.

5. The apparatus according to claim 4, further comprising:
a detector configured to detect an intensity of the pattern light generated by the mask; and
a control unit configured to control the first change unit based on a detection result of the detector.

6. The apparatus according to claim 1, further comprising:
a second change unit configured to change relative tilts of the light source and the mask.

7. The apparatus according to claim 6, further comprising:
a detector configured to detect an intensity of the pattern light generated by the mask; and
a control unit configured to control the second change unit based on a detection result of the detector.

8. The apparatus according to claim 1, further comprising:
a third change unit configured to change relative positions of the light source and the mask in a direction parallel to an optical axis of the optical system.

9. The apparatus according to claim 8, further comprising:
a detector configured to detect an intensity of the pattern light generated by the mask; and
a control unit configured to control the third change unit based on a detection result of the detector.

10. The apparatus according to claim 1, wherein an area of the reflecting regions is larger than an area of the transmitting regions.

11. A system comprising:
a measurement apparatus configured to measure an object using pattern light; and
a robot configured to hold and move the object based on a measurement result of the measurement apparatus,
wherein the measurement apparatus includes:
a light source having a structure including a light emitting portion for emitting light and a reflecting portion for reflecting light;
a mask including a pattern region in which transmitting regions for transmitting light and reflecting regions for reflecting light are periodically arranged, and configured to generate the pattern light;
an optical system arranged between the light source and the mask;
an imaging unit configured to image the object irradiated with the pattern light; and
a processor configured to obtain the shape of the object based on an image obtained by the imaging unit,
wherein the light source, the optical system, and the mask are arranged so that light emitted from the light source is incident on the reflecting region of the mask via the optical system, is reflected by the reflecting region to return to the light source via the optical system, and then is reflected by the reflecting portion of the light source to enter the transmitting region of the mask via the optical system.

12. A method of manufacturing an article, comprising:
holding and moving, by a robot, a part measured by a measurement apparatus; and
manufacturing the article by performing one of processing and assembling of the moved part,
wherein the measurement apparatus measures a shape of an object using pattern light, and includes:
a light source having a structure including a light emitting portion for emitting light and a reflecting portion for reflecting light;
a mask including a pattern region in which transmitting regions for transmitting light and reflecting regions for reflecting light are periodically arranged, and configured to generate the pattern light;
an optical system arranged between the light source and the mask;
an imaging unit configured to image the object irradiated with the pattern light; and
a processor configured to obtain the shape of the object based on an image obtained by the imaging unit,
wherein the light source, the optical system, and the mask are arranged so that light emitted from the light source is incident on the reflecting region of the mask via the optical system, is reflected by the reflecting region to return to the light source via the optical system, and then is reflected by the reflecting portion of the light source to enter the transmitting region of the mask via the optical system.
